(19) United States
(12) Patent Application Publication
(10) Pub. No.: US 2016/0290012 A1
(43) Pub. Date: Oct. 6, 2016

(54) LOCKING DEVICE

(71) Applicant: Henry Squire & Sons Ltd, Wolverhampton (GB)

(72) Inventors: John Charnley, Newcastle upon Tyne (GB); Clinton Sheppard, Idaho Falls, ID (US); Glyn Green, Cannock (GB)

(21) Appl. No.: 15/089,996

(22) Filed: Apr. 4, 2016

(30) Foreign Application Priority Data
Apr. 3, 2015 (GB) 1505821.7

(51) Int. Cl. E05B 63/00; E05B 27/00

(52) U.S. Cl. CPC E05B 63/0056; E05B 27/0003; E05B 27/0017; E05B 27/0039; E05B 27/005

(57) ABSTRACT

A locking device, particularly a pin tumbler lock, is disclosed. The lock has a barrel with pin pathways formed therein and a plug. The plug includes a cassette with further pin pathways and a body for receiving the cassette. Key pins, driving pins and springs are contained within the pin pathways. The device includes a fixing grub screw for selectively fixing the body to either said barrel or said cassette, thereby allowing easy re-pinning of the plug.

### CROSS-REFERENCE TO RELATED APPLICATIONS

This application claims priority under 35 U.S.C. §119 to United Kingdom Patent Application No. 1505821.7, filed Apr. 3, 2015, the entirety of which is hereby incorporated herein by reference.

### FIELD OF THE INVENTION

The present invention relates to a locking device and relates particularly, but not exclusively, to pin tumbler cylinder locks where key changes are frequently required.

### BACKGROUND OF THE INVENTION

The use of pin tumbler cylinder locks is very commonplace and they are regularly used as a main lock on a property. It is not uncommon for there to be a need to regularly change a lock on a door. For example, a landlord may wish to change the key that is used to unlock a door as tenants change on their rental properties. This can be achieved by simply removing and replacing the whole cylinder. However, this is expensive and wasteful of materials. An alternative is to re-pin the lock thereby changing the combination of pins and therefore the key that will open the lock. Re-pinning a lock is a difficult process requiring the significant skills of a locksmith and is time-consuming. It is a process that is particularly difficult to perform in the field where the small components such as the pins and springs of the lock can be easily lost.

In the manufacture and maintenance of cylinder locks it is desirable to be able to easily provide different key pathways, that is, locks that work with keys having a different cross-sectional shape. In order to be able to fit a cylinder lock with a new plug containing a new key pathway it is necessary for a locksmith to maintain stocks of the plugs for each of the styles of cylinder lock and for each of the key pathway shapes that may be required. As a result, a locksmith is required to carry significant stocks of cylinder lock components in order to perform all the desired maintenance and refurbishment of cylinder locks.

### BRIEF SUMMARY OF THE INVENTION

Preferred embodiments of the present invention seek to overcome the above described disadvantages of the prior art.

According to an aspect of the present invention there is provided a pin tumbler locking device comprising: at least one barrel having a plurality of first pin pathways formed therein for receiving one or more pins movable axially along said first pin pathway; at least one plug at least partially contained and rotatable within said barrel, said plug comprising a cassette having a key pathway for receiving a key and a plurality of second pin pathways for receiving one or more pins movable along said second pin pathway, said second pin pathway capable of aligning with said first pin pathway, and a body having a cassette receiving portion for receiving and engaging said cassette; a plurality of pins contained within said first and second pin pathways and divided into key pins for engaging a key inserted into said key pathway and driving pins engaging said key pins; a plurality of biasing devices biasing said driving pins towards said key pathway; and at least one fixing device for selectively fixing said body to said cassette.

By providing a plug having a cassette and a body which are selectively fixed together, provides the advantage that the cassette can be removed from the body whilst the body remains within the remainder of the locking device. This is particularly advantageous as the cassette, with the key pins contained therein, can be removed from the locking device without the springs and the driving pins being removed. In order to do this the key is inserted into the key pathway which aligns the engaged ends of the key pins and driving pins with the sheer line of the lock. The plug (that is the cassette and the body) can be rotated within the barrel and the body prevents the driver pins from moving out of the first pin pathways. With the body in this position the fixing device can be removed allowing the cassette and the body to separate. The removal of the cassette also removes the key pins. A new cassette with new key pins or the existing cassette with new key pins can be reinserted into the body and the cassette and body fixed to each other once more. This is all that is required to change the pinning combination of the lock and also allows the key pathway to be changed if required by changing to a new cassette. This is significantly quicker and easier than any re-pinning methods of the prior art. This rapid re-pinning of the lock can be achieved in the field, by a locksmith in their workshop or during manufacture. Since only the cassette is being changed the cost of replacing the cassette is significantly less than the cost of replacing the lock, which is presently often done in preference to attempting to re-pin. Furthermore, the stock that is required by a locksmith in order to achieve the changing of the lock is significantly less if one cassette will operate with several different locks.

In a preferred embodiment at least one fixing device selectively fixes said body to either said barrel or said cassette.

By providing the apparatus such that the fixing device selectively fixes the body to either the barrel or the cassette provides the advantage that when the body is fixed to the cassette the lock operates in the normal manner. When the body is fixed to the barrel, rotation of the barrel is not possible and with the body no longer fixed to the cassette, the cassette can be removed. With the position that the barrel fixes to the body being the partially rotated position, the cassette and key pins can be removed from the lock and replaced but the driving pins and springs are retained in position by the body. As a result, the removal of the cassette can be achieved without having to hold the barrel in position. In other words, a locksmith is able to lock the body to the barrel with the driving pins secured in position and once the cassette has been removed the locking apparatus can be put to one side whilst the locksmith sorts out the replacing of the cassette and/or pins.

The cassette may comprise first and second cassette portions, said key pathway forming between said first and second cassette portions.

By forming the cassette in two halves, the advantage is provided new key pathways can be created by combining different first and second cassette portions. Furthermore, a key pathway can be changed by simply altering one of the cassette portions thereby giving a large variety of potential key pathways from a small number of cassette portion combinations. This in turn allows a large number of key pathways to be provided from a very small stock of cassette portions held by the manufacturer and locksmith.

In another preferred embodiment at least one of said first and second cassette portions is formed by casting.

Forming the cassette by casting is only possible by having first and second cassette portions. Casting is a very cost-effective way of forming components. The cassette portions can be cast from stainless steel or other hard metals. However, if a softer cast metal is used the integrity of the lock is not compromised because the cassette forms a small part of the whole locking apparatus and is surrounded by harder materials.

The body may further comprise a replaceable extension portion for varying the length of the barrel.

An extension portion provided on the body of the plug allows the same combination of cassette and body (that together form the plug) to be used in locking apparatus with different lengths of barrels. This further reduces the volume of stock required to be held by the lock manufacturer and locksmith as the same plug will operate in different lengths of barrel.

The fixing device may comprise a threaded member extending into threaded apertures in said barrel and said body to fix the barrel and body and extending into said threaded aperture in said body and a recess in said cassette for fixing said body to said cassette.

Providing a fixing device in the form of a threaded member which extends through threaded apertures in the barrel and body and into a recess in the cassette provides the advantage that the threaded member can be simply rotated to move from a position in which it locks the cassette to the body into a position in which it locks the body to the barrel. As a result, the action that is required to change the cassette is simply to insert the key and rotate the plug until the threaded member is aligned with the threaded aperture in the barrel. A suitable tool for engaging the grub screw is inserted through the threaded aperture in the barrel and this is rotated until the grub screw engages both the thread of the body and the threat of the barrel and no longer extends into the recess in the cassette. The cassette can now be removed from the body and the body does not rotate and prevents the driving pins and springs from moving within the first pin pathways. The cassette can be re-pinned and replaced and the grub screw is then rotated in the opposite direction so that it no longer engages the threaded aperture in the barrel and extends into the recess in the cassette. These simple actions allow re-pinning of a locking apparatus in a simple manner which previously required the skills and time of a locksmith.

According to another aspect of the present invention there is provided a cassette forming part of a pin tumbler locking device having at least one barrel having a plurality of first pin pathways formed therein for receiving one or more pins movable axially along said first pin pathway, the device also having at least one plug at least partially contained and rotatable within said barrel, said plug including a body having a cassette receiving portion for receiving and engaging the cassette, the device further having a plurality of pins contained within said first and second pin pathways and divided into key pins for engaging a key inserted into said key pathway and driving pins engaging said key pins and a plurality of biasing devices biasing said driving pins towards said key pathway, the cassette comprising: a key pathway for receiving a key and a plurality of second pin pathways for receiving one or more pins movable along said second pin pathway, said second pin pathway capable of aligning with said first pin pathway and at least one fixing device for selectively fixing said body to said cassette.

In a preferred embodiment at least one fixing device selectively fixes said body to either said barrel or said cassette.

The cassette may comprise first and second cassette portions, said key pathway forming between said first and second cassette portions.

In a preferred embodiment at least one of said first and second cassette portions is formed by casting.

The fixing device may comprise a threaded member extending into threaded apertures in said barrel and said body to fix the barrel and body and extending into said threaded aperture in said body and a recess in said cassette for fixing said body to said cassette.

According to another aspect of the present invention there is provided a method of re-pinning a locking device as set out above, comprising the steps: aligning engaged ends of the key pins and driving pins with a shear line formed at the junction of said first and second pin pathways; rotating the plug within the barrel; moving the fixing device from engagement with the cassette; removing the cassette and key pins and replacing or rearranging the key pins to align with the new key; inserting the cassette and key pins into the body; and moving the fixing device into engagement with said cassette.

In a preferred embodiment when the fixing device moves from engagement with the cassette it moves into engagement with the barrel whilst remaining in engagement with the body, thereby fixing the body to the barrel.

In another preferred embodiment when the fixing device moves into engagement with the cassette it moves from engagement with the barrel whilst remaining in engagement with the body, thereby fixing the body to the cassette.

### BRIEF DESCRIPTION OF THE DRAWINGS

Preferred embodiments of the present invention will now be described, by way of example only, and not in any limitative sense with reference to the accompanying drawings in which:

FIG. 1 is a side view of an apparatus of an embodiment of the present invention with some internal features shown in dotted lines;

FIG. 2 is an exploded perspective view of the apparatus of FIG. 1;

FIGS. 3 and 4 for sectional views along the lines A-A and B-B of the apparatus of FIG. 1;

FIGS. 5 and 6 are end view from opposing ends of the apparatus of FIG. 1; and

FIGS. 7, 8 and 9 are exploded perspective, side and end views of another embodiment of the present invention.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

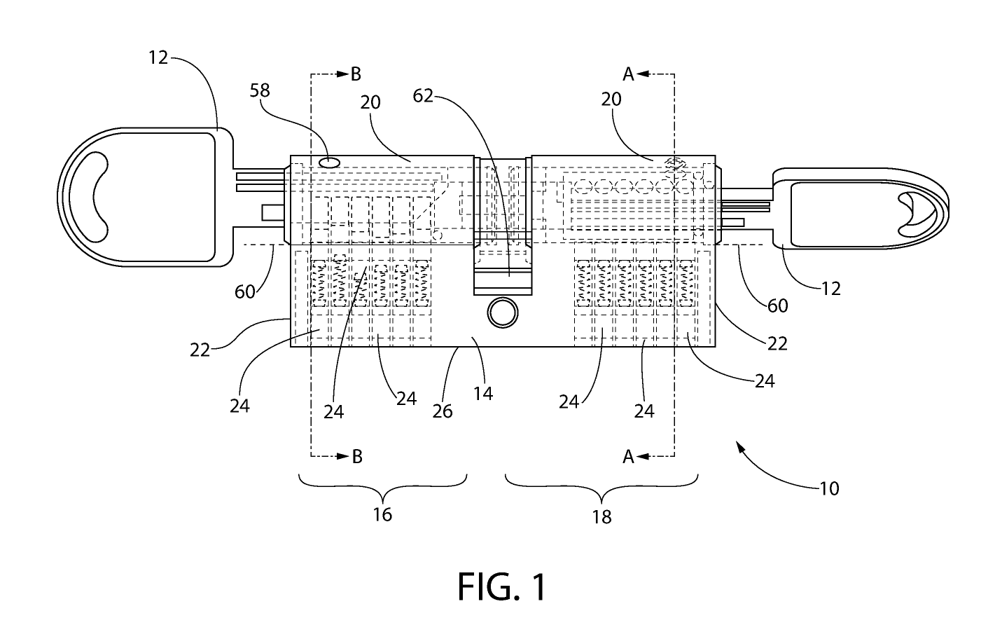

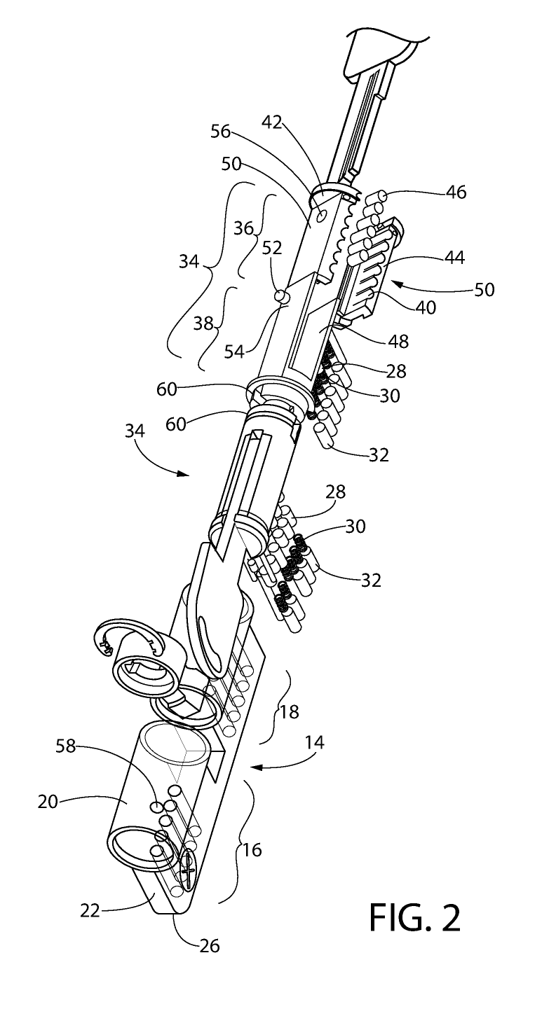

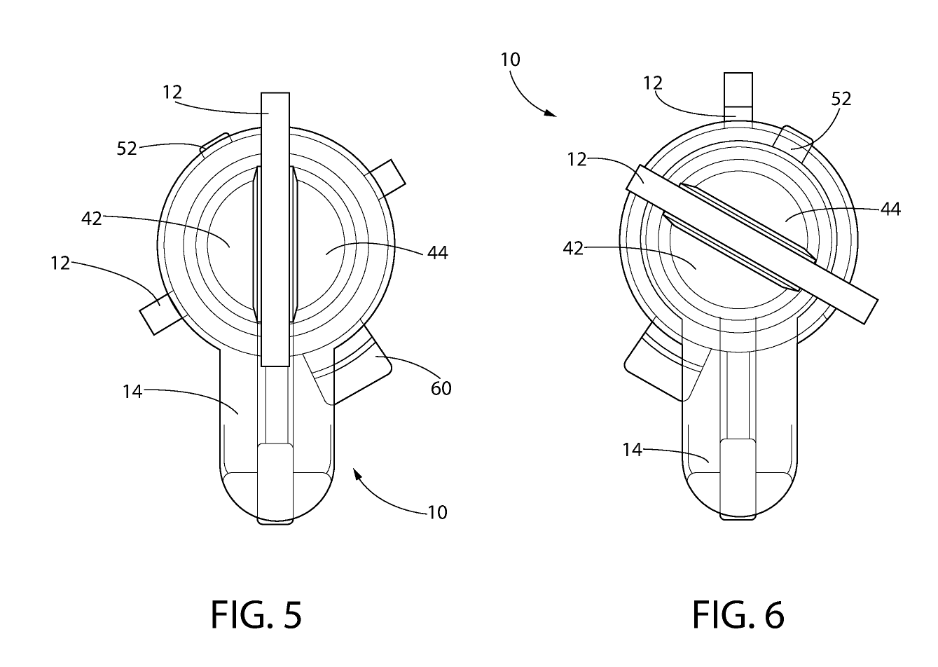

Referring to FIGS. 1 to 6, a locking device 10 is a pin tumbler type locking device and is operated using keys 12. The locking device 10 has a barrel 14 which is divided into left and right barrel sections 16 and 18. Each barrel section has a cylindrical part 20 and an extension part 22 which together form the shape of the Europrofile lock familiar to person skilled in the art. The barrel 14, and in particular the extension part 22 includes a plurality of first pin pathways 24 that are formed as apertures extending from a bottommost surface 26 of the extension part 22 through the extension part and into the cylindrical part 20. Each of the first pin pathways contains a driving pin 28, a biasing device in the form of a spring 30 and an end cap 32 which closes the aperture forming the first pin pathway at the bottom end adjacent surface 26.

The locking device 10 also includes a plug 34 which is formed from a cassette 36 and a body 38. The cassette 36 has a key pathway which is shaped to receive a key and has a plurality of second pin pathways 40. In the embodiments shown the cassette 36 is formed from two cassette portions, referred to as the first and second cassette portions 42 and 44. Each cassette portion is formed by casting although other production techniques may be used. The second pin pathways 40 lie along the junction between the first and second cassette portions 42 and 44 and therefore appear as a series of semicircular ridges formed in the adjacent surfaces of the cassette portions. When the first and second cassette portions 42 and 44 are engaged with each other the semicircular ridges are aligned to form circular apertures within which a series of key pins 46 can be located. The cassette 36 and body 38 are shaped to engage with each other and form of the plug 34. In the embodiment shown the body 38 has a large slot cut into it with parallel facing sides 48. The outer surfaces of the cassette portions 42 and 44, that is, the surfaces on the opposing side to the ridges that form the second pin pathways, have substantially planar surfaces 50 that engage the parallel facing surfaces 48 of the body 38. When cassette 36 is inserted into the body 38 the plug so formed has an annular outer surface which engages the inner surface of the cylindrical part 20 of barrel 14, as is standard for a plug in a Europrofile barrel.

To ensure that the cassette 36 remains in engagement with the body 38 a fixing device, in the form of grub screw 52 extends into a threaded aperture 54 formed in the body 38. The threaded aperture 54 extends from the outer curved surface of the body 38 and through to one of the inner parallel facing surfaces 48. A recess 56 is formed in the planar surface 50 of one of the cassette portions and this recess is aligned with the threaded aperture 54 when the cassette 36 and body 38 are engaged with each other. Although not essential, the recess 56 can also be threaded to engage the thread of the grub screw 52. Only one grub screw 52 and associated aperture 54 and recess 56 are required to retain the cassette portions within the body 38 since, when the plug 34 is assembled and contained within the barrel section 16 or 18, the inner surfaces of the barrel section prevent any movement of the cassette portions parallel to the pin pathways.

Each of the barrel section 16 and 18 is provided with another aperture 58 which is preferably threaded and which is positioned so that when the plug 34 is rotated to a predetermined position the threaded aperture 54 of the body 38 is aligned with the threaded aperture 58 of the barrel 14. The thread of the threaded aperture 58 matches that of the grub screw 52 so that when the apertures 54 and 58 are aligned the grub screw can be rotated so as to partially extend into the threaded aperture 58.

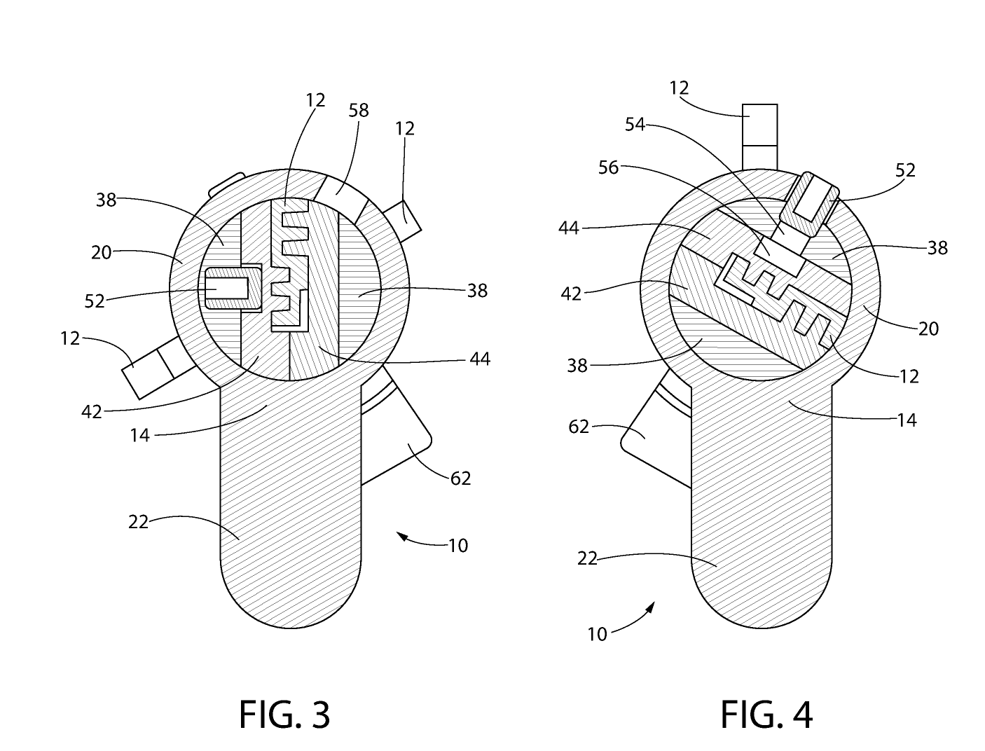

Operation of the present invention will now be described. When the lock is fully assembled it operates in the manner familiar to person skilled in the art. When a key 12 is inserted into the keyway between the first and second cassette portions 42 and 44, the key causes the key pins 46 to move within the second pin pathways 40. If the correct key 12 has been inserted the key pins 46, which are engaged with the driver pins 28, the point at which the key pins and driver pins engage each other will align in a linear fashion along the sheer line 60 which is a line connecting the top ends of the first pin pathways 24 where the extension part 22 meets the cylinder part 20 of the barrel 14. When the junction between the pins is aligned with the sheer line 60 the plug 34 is able to rotate within the barrel 14 which allows rotation of the cam 62 which operates the door locking mechanism (not shown). This is the condition shown in FIG. 3.

If the locking device 10 is not located in a door (so that the sides of the barrel are accessible) then a suitable tool inserted into the aperture 58 to engage and to rotate the grub screw 52. This rotation of the grub screw will cause it to retract out of the recess 56 in cassette 36 thereby releasing the cassette from the body 38. At the same time, the grub screw 52 will begin to engage the thread in aperture 58 thereby fixing the body to the barrel 14. This is the condition shown in FIG. 4. Once the cassette 36 is freed from the body 38 and the body is fixed to the barrel 14, the plug 34 cannot move but the cassette 36 can be removed from the body. The key pins 46 can be replaced to match a new key and one or both of the cassette portions 42 and 44 can also be replaced if required. The cassette is then returned to the locking device 10 and when the cassette 36 is once again in engagement with the body 38 the same tool can be used to rotate the grub screw 52 in the opposite direction. This will result in the grub screw retracting from the aperture 58 and cause it to extend into the recess 56 thereby releasing the body 38 from its fixed engagement with the barrel 14 and fixing the body to the cassette 36 once more. The locking device is now ready for use.

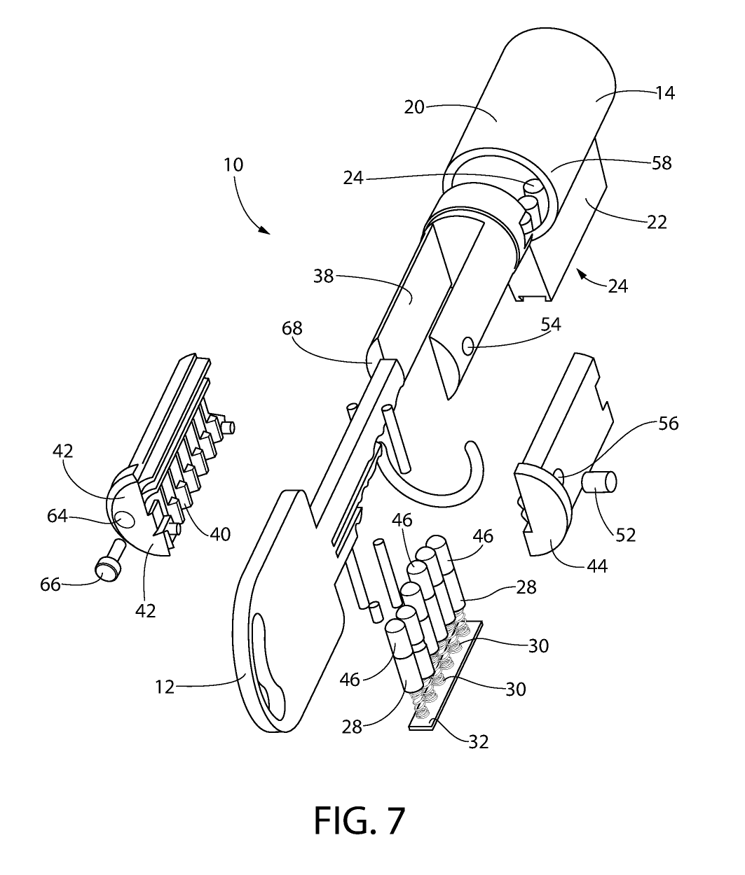

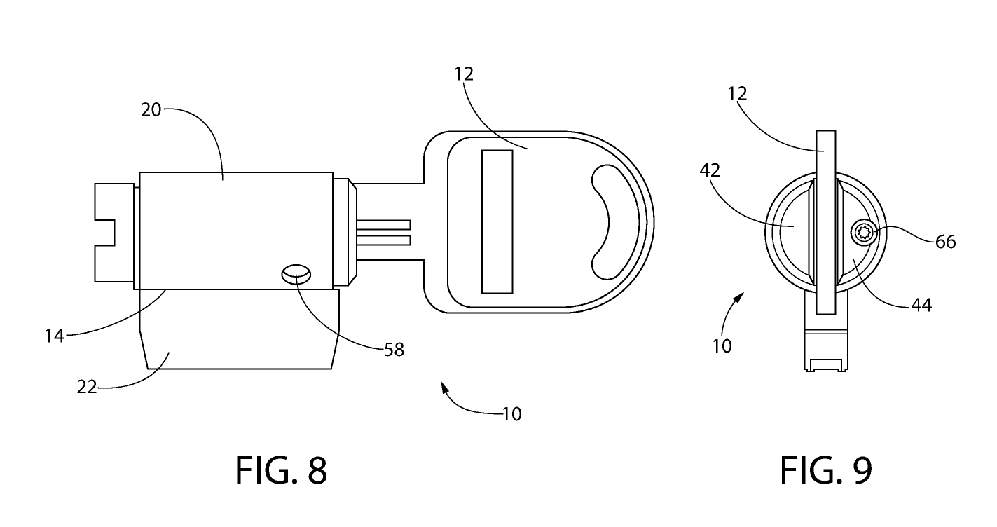

It will be appreciated by persons skilled in the art that the above embodiments have been described by way of example only and not in any limitative sense, and that various alterations and modifications are possible without departure from the scope of the protection which is defined by the appended claims. For example, a variation of the locking device 10 is shown in FIGS. 7 to 9. This device 10 is almost identical to that previously described (the figures showing only half the locking device) except that one of the cassette portions (in this example the first cassette portion 42) has an additional aperture 64 through which a second fixing device, in the form of a threaded bolt 66 having a non-standard head adapted to match a non-standard tool (not shown). The bolts 66 extend through the aperture 64 into a further threaded aperture 68 in the end of body 38.

This bolt 66 and its associated apertures 64 and 68 can be used in addition to the previously described grub screw 52 but in situations where the security requirements are lower it can be used instead of the grub screw 52. The grub screw and its associated apertures and recess can be completely removed from the device. As a result, the cassette 36 can be removed from engagement with the body 38 without the need to remove the locking device 10 from the door in which it is located. In order to do this the correct key is inserted into the lock and rotated so that the body comes into engagement with the end of the driving pins along the sheer line. The bolts 66 can be removed thereby freeing the cassette 36 which can then be withdrawn from the body 38. If the body 38 can be maintained in the rotated position the driving pins will remain in the first pin pathways 24 whilst the cassette 36 and or key pins 46 are replaced. A non-standard head on bolt 66 is used in order to prevent this bolt from being removed in an attempt to overcome the locking device.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A pin tumbler locking device comprising:
at least one barrel having a plurality of first pin pathways formed therein for receiving one or more pins movable axially along said first pin pathway;
at least one plug at least partially contained and rotatable within said barrel, said plug comprising:
a cassette having a key pathway for receiving a key and a plurality of second pin pathways for receiving one or more pins movable along said second pin pathway, said second pin pathway capable of aligning with said first pin pathway, and
a body having a cassette receiving portion for receiving and engaging said cassette;
a plurality of pins contained within said first and second pin pathways and divided into key pins for engaging a key inserted into said key pathway and driving pins engaging said key pins;
a plurality of biasing devices biasing said driving pins towards said key pathway; and
at least one fixing device for selectively fixing said body to said cassette.

2. The locking device according to claim 1, wherein said at least one fixing device selectively fixes said body to either said barrel or said cassette.

3. The locking device according to claim 1, wherein said cassette comprises first and second cassette portions, said key pathway forming between said first and second cassette portions.

4. The locking device according to claim 3, wherein at least one of said first and second cassette portions is formed by casting.

5. The locking device according to claim 1, wherein said body further comprises a replaceable extension portion for varying the length of the barrel.

6. The locking device according to claim 1, wherein said fixing device comprises a threaded member extending into threaded apertures in said barrel and said body to fix the barrel and body and extending into said threaded aperture in said body and a recess in said cassette for fixing said body to said cassette.

7. A cassette forming part of a pin tumbler locking device having at least one barrel with a plurality of first pin pathways formed therein for receiving one or more pins movable axially along said first pin pathway, the device also having at least one plug at least partially contained and rotatable within said barrel, said plug including a body having a cassette receiving portion for receiving and engaging the cassette, the device further having a plurality of pins contained within said first and second pin pathways and divided into key pins for engaging a key inserted into said key pathway and driving pins engaging said key pins and a plurality of biasing devices biasing said driving pins towards said key pathway, the cassette comprising:
a key pathway for receiving a key and a plurality of second pin pathways for receiving one or more pins movable along said second pin pathway, said second pin pathway capable of aligning with said first pin pathway and at least one fixing device for selectively fixing said body to said cassette.

8. The cassette according to claim 7, wherein at least one fixing device for selectively fixing said body to either said barrel or said cassette.

9. The cassette according to claim 7, wherein said cassette comprises first and second cassette portions, said key pathway forming between said first and second cassette portions.

10. The cassette according to claim 9, wherein at least one of said first and second cassette portions is formed by casting.

11. The cassette according to claim 7, wherein said fixing device comprises a threaded member extending into threaded apertures in said barrel and said body to fix the barrel and body and extending into said threaded aperture in said body and a recess in said cassette for fixing said body to said cassette.

12. A method of re-pinning a locking device according to claim 1, comprising the steps:
aligning engaged ends of the key pins and driving pins with a shear line formed at the junction of said first and second pin pathways;
rotating the plug within the barrel;
moving the fixing device from engagement with the cassette;
removing the cassette and key pins and replacing or rearranging the key pins to align with the new key;
inserting the cassette and key pins into the body; and
moving the fixing device into engagement with said cassette.

13. The method according to claim 12, wherein when the fixing device moves from engagement with the cassette it moves into engagement with the barrel whilst remaining in engagement with the body, thereby fixing the body to the barrel.

14. The method according to claim 13, wherein when the fixing device moves into engagement with the cassette it moves from engagement with the barrel whilst remaining in engagement with the body, thereby fixing the body to the cassette.
